(19) United States
(12) Patent Application Publication
(10) Pub. No.: US 2026/0369892 A1
(43) Pub. Date: Nov. 19, 2026

(54) TECHNIQUES FOR PEAKING REFLECTOR ANTENNAS

(71) Applicant: Viasat, Inc., Carlsbad, CA (US)

(72) Inventor: John D. VOSS, Cumming, GA (US)

(21) Appl. No.: 19/126,221

(22) PCT Filed: Nov. 1, 2023
(86) PCT No.: PCT/US2023/036574

§ 371 Date: Apr. 30, 2025

Related U.S. Application Data
(60) Provisional application No. 63/381,871, filed on Nov. 1, 2022.

(51) Int. Cl. H01Q 19/13; H01Q 1/12; H01Q 3/18

(52) U.S. Cl. CPC H01Q 19/132; H01Q 1/1257; H01Q 3/18

(57) ABSTRACT

Methods, systems, and devices supporting techniques for peaking reflector antennas are described. An antenna system may include a reflector and an antenna feed configured to communicate signaling with a target device via the reflector (e.g., along a direction of peak gain of the antenna system). The antenna system may also include a feed positioning mechanism configured to displace the antenna feed relative to the reflector, such as along a non-linear path in response to an actuation of single drive interface of the feed positioning mechanism. In some implementations, a feed positioning mechanism may include one or more gears operable to displace the antenna feed along a pattern, such as a hypotrochoid pattern. Such displacement of an antenna feed may change a direction of peak gain of the antenna system without moving the reflector (e.g., may change a direction of peak gain relative to the reflector).

### CROSS REFERENCES

The present Application for Patent is a 371 national phase filing of International Patent Application No. PCT/US2023/036574 by Voss, entitled “TECHNIQUES FOR PEAKING REFLECTOR ANTENNAS” filed Nov. 1, 2023, which claims the benefit of U.S. Provisional Patent Application No. 63/381,871 by Voss, entitled “LOW COST AUTO-PEAKING REFLECTOR ANTENNA,” filed Nov. 1, 2022, each of which is assigned to the assignee hereof and each of which is expressly incorporated by reference in its entirety herein.

### FIELD OF TECHNOLOGY

The present disclosure relates to antenna systems, including techniques for peaking reflector antennas.

### BACKGROUND

An antenna (e.g., a directional antenna, a reflector antenna, an antenna system) may be installed with a direction of peak gain that is aligned along a direction toward a target. For example, an installer may mount (e.g., attach, immobilize) a support structure of the antenna to an object (e.g., ground, a mast, a building or other structure) and perform an alignment process to align the direction of peak gain of the antenna towards a target (e.g., a target device, a target antenna, an antenna of a geostationary satellite). The alignment process may include loosening one or more fasteners on a mounting bracket of the antenna and physically moving a portion of the antenna (e.g., a portion that includes a reflector and an antenna feed that may be located at a focal region of the reflector) until sufficiently pointed at the target device using a signal metric (e.g., signal quality, signal strength) of a signal communicated between the antenna and the target. After the direction of peak gain is sufficiently aligned with the target, the installer may tighten the fasteners to immobilize the mounting bracket. However, in some examples, a signal gain for communications between the antenna and the target may be relatively low (e.g., compared to a gain capability of the antenna) due to manual pointing accuracy limitations, a relatively low threshold for establishing antenna alignment, a change of alignment of the antenna (e.g., slippage, movement of a mounting structure), or a change of position of the target, among other influences or combinations thereof.

A misalignment between a direction of peak gain of an antenna and a direction of a target relative to the antenna may result in a detrimental effect on the quality of communications between the antenna and the target. Small misalignments may be compensated for by reducing a modulation and coding rate of signals communicated between the antenna and the target. However, to maintain a given data rate (e.g., bits-per-second (bps)), such an approach may increase system resource usage and result in inefficient use of the resources. In addition, after installation it may be difficult to determine whether performance degradation is due to misalignment of the antenna or some other cause. Diagnosing degraded performance may involve allocating an installation or maintenance resource to the location of the antenna to evaluate the cause and attempt to correct it, which may increases costs for managing a communications system.

### SUMMARY

The described techniques relate to improved methods, systems, and apparatuses that support peaking reflector antennas, such as those that may be used for communications with or via a satellite (e.g., a satellite in a geostationary (GEO) orbit) or other target device. For example, an antenna system may include a reflector and an antenna feed configured to communicate (e.g., receive, transmit) signals reflected by the reflector, and such an antenna system may be associated with a direction of peak gain (e.g., for signals reflected by the reflector). Such an antenna system may also include an antenna feed positioning mechanism configured to displace the antenna feed relative to the reflector along multiple dimensions (e.g., along a non-linear path), which may be implemented using a single drive interface for driving the displacement (e.g., using a single actuator, such as a motor, a wrench, a screwdriver, or other tool). Displacing the antenna feed relative to the reflector may change a direction of peak gain of the antenna system (e.g., a direction of peak gain relative to the reflector) without repositioning the reflector, which may improve signal gain along a direction toward a target device without moving the entire antenna system, for example.

In some implementations, an antenna feed positioning mechanism may include a gear assembly configured to be driven by a motor or tool to displace the antenna feed relative to the reflector. For example, a signal strength of the antenna system may be measured as the antenna feed is displaced in a pattern relative to the reflector, and an actuator may be controlled (e.g., by a controller, by an installer) to displace the antenna feed to a position of the pattern that is associated with a relatively highest signal quality (e.g., a highest measured signal strength, signal-to-noise ratio (SNR), or signal-to-interference-plus-noise ratio (SINR)). Improving the signal quality based on displacing the antenna feed may improve a communications link between an antenna system and a target device, thereby reducing resource usage of communications using the antenna system and improving network efficiency. Further, the described techniques for an antenna feed positioning mechanism may be implemented with relatively low cost and low complexity, and may support techniques for periodic or event-driven realignments (e.g., implementing a controller of the antenna system).

Further scope of the applicability of the described methods and systems will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

FIG. 1 shows a diagram of a communication system that supports techniques for peaking reflector antennas in accordance with examples as disclosed herein.

FIG. 2 shows a block diagram of a user terminal that supports techniques for peaking reflector antennas in accordance with examples as disclosed herein.

FIGS. 3A and 3B show an example of an antenna system that supports techniques for peaking reflector antennas in accordance with examples as disclosed herein.

FIGS. 4A and 4B show examples of a displacement geometry diagram and a displacement path diagram that support techniques for peaking reflector antennas in accordance with examples as disclosed herein.

FIGS. 5A and 5B show an example of a signaling assembly that supports techniques for peaking reflector antennas in accordance with examples as disclosed herein.

FIGS. 6A, 6B, 6C, and 6D show an example of a mechanism that supports techniques for peaking reflector antennas in accordance with examples as disclosed herein.

FIGS. 7A and 7B show an example of a flexure that supports techniques for peaking reflector antennas in accordance with examples as disclosed herein.

FIG. 8 shows an example of an antenna system that supports techniques for peaking reflector antennas in accordance with examples as disclosed herein.

FIG. 9 shows a flowchart illustrating a method that support techniques for peaking reflector antennas in accordance with examples as disclosed herein.

### DETAILED DESCRIPTION

The described features relate to techniques for peaking reflector antennas, such as those that may be used for communications with a target device, such as a satellite. For example, an antenna system may include a reflector and an antenna feed configured to communicate (e.g., receive, transmit) signals reflected by the reflector with the target device. Such an antenna system may be associated with a direction (e.g., orientation) of peak gain (e.g., for signals reflected by or from the reflector), such that a direction of the antenna system relative to the target device may alter the quality (e.g., strength) of signals communicated between the antenna system and the target device. In some cases, the antenna system may be misaligned with the target device, resulting in reduced signal quality. For example, an imprecise installation of the antenna system, movement of the antenna system or components thereof (e.g., due to external forces affecting the antenna system, such as environmental conditions), or movement of a target device may cause the antenna system to become misaligned from the target device. Misalignment between a direction of peak gain of an antenna system and a target device may result in inefficient communication or signaling performance via the antenna system, which may adversely affect throughput or efficiency of an associated network.

In accordance with examples as disclosed herein, an antenna system may include an antenna feed positioning mechanism configured to position an antenna feed relative to a reflector, such as non-linear displacements using a single drive interface. For example, an antenna system may be mounted such that at least the reflector is maintained at a fixed position, and the antenna feed may be displaced relative to the fixed position of the reflector to adjust a direction of peak gain of the antenna system as a whole. In some examples, an antenna feed positioning mechanism may be configured to displace the antenna feed along a planar path relative to the reflector based on an actuation from a single drive interface (e.g., a motor, a tool). In some examples, such an antenna feed positioning mechanism may include a gear assembly operable by a single drive interface to translate the antenna feed along the plane in a pattern (e.g., a hypotrochoid pattern), which may support identifying a position (e.g., a physical position associated with displacement within the plane) of the antenna feed that improves alignment between the direction of peak gain of the antenna system and a target. In some cases, the antenna feed positioning mechanism may be controlled based on a measured or indicated quality of a signal communicated between the antenna system and the target device.

Implementing such an antenna feed positioning mechanism may support relatively improved communication or signaling performance of the antenna system. For example, improving signal quality based on displacing the antenna feed may improve a communications link between an antenna system and a target device, thereby reducing resource usage of communications using the antenna system and improving network efficiency. Further, the described techniques for an antenna feed positioning mechanism may be implemented with relatively low cost and low complexity, and may support techniques for periodic or event-driven realignments (e.g., implementing a controller of the antenna system).

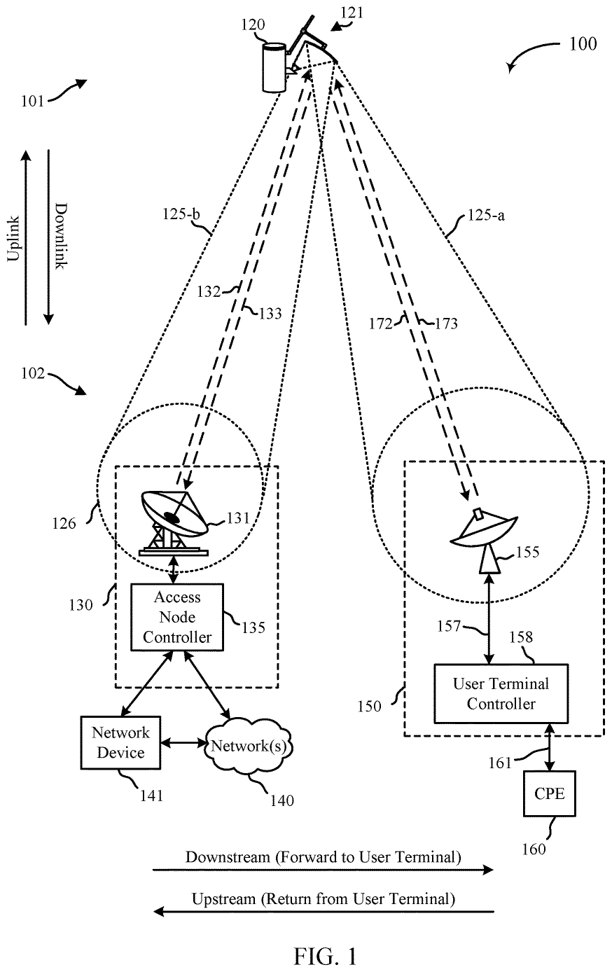

FIG. 1 shows a diagram of a communication system 100 (e.g., a satellite communication system) that supports techniques for peaking reflector antennas in accordance with examples as disclosed herein. A communication system 100 may use various network architectures to support a communications service, such as an architecture including a space segment 101 and ground segment 102. A space segment 101 may include one or more satellites 120 (e.g., one or more communications satellites). A ground segment 102 may include one or more user terminals 150 (e.g., satellite terminals) and one or more access node terminals 130 (e.g., gateway terminals), as well as network devices 141 such as network operations centers (NOCs), and satellite and gateway terminal command centers. The terminals of the communication system 100 (e.g., access node terminals 130) may be connected to each other, or to one or more networks 140, via a mesh network, a star network, or other network architecture.

A satellite 120 may include any suitable type of satellite configured for wireless communication with or between access node terminals 130 and user terminals 150. In some examples, some or all of the satellites 120 may be in geostationary orbits, such that their locations with respect to terrestrial devices may be relatively fixed, or fixed within an operational tolerance or other orbital window. Additionally, or alternatively, some or all of the satellites 120 may be in orbits for which a position of the satellite 120 relative to the earth changes over time (e.g., a non-geostationary orbit such as a low Earth orbit (LEO) or medium Earth orbit (MEO)). Although some techniques are described herein with reference to a satellite 120 being an example of a target device (e.g., for a user terminal 150 or antenna system 155 thereof), the techniques described herein are applicable to other target devices, including other types of target devices, which may have a generally overhead location relative to a user terminal 150 (e.g., a plane, an unmanned aerial vehicle, a drone, a dirigible, a terrestrial relay antenna).

A satellite 120 may receive uplink signals 132 (e.g., forward uplink signals) from one or more access node terminals 130, and transmit downlink signals 172 (e.g., forward downlink signals) to one or more user terminals 150. Additionally, or alternatively, a satellite 120 may receive uplink signals 173 (e.g., return uplink signals) from one or more user terminals 150 and transmit downlink signals 133 (e.g., return downlink signals) to one or more access node terminals 130. Various physical layer modulation and coding techniques may be supported for the communication of signals between access node terminals 130 and user terminals 150 (e.g., via a satellite 120), such as multi-frequency time-division multiple access (MF-TDMA), time division multiple access (TDMA), frequency division multiple access (FDMA), orthogonal frequency division multiple access (OFDMA), code division multiple access (CDMA), or any quantity of hybrid or other schemes known in the art. In various implementations, physical layer techniques may be the same for each of the signals 132, 133, 172, and 173, or some of the signals may use different physical layer techniques than other signals. A satellite 120 may support communications using one or more frequency bands, and any quantity of subbands thereof. For example, the satellite 120 may support operations in the International Telecommunications Union (ITU) Ku, K, or Ka-bands, C-band, X-band, S-band, L-band, V-band, among other frequency bands or combinations thereof.

A satellite 120 may include an antenna assembly 121, such as an array antenna, a phased array antenna assembly, a phased array fed reflector (PAFR) antenna, or any other system known in the art for transmission and/or reception of signals of a communications service. In some examples, an antenna assembly 121 may support communication via one or more spot beams 125, which may be referred to as beams, service beams, beamformed beams, satellite beams, or any other suitable terminology. Signals may be passed via the antenna assembly 121 to form the spatial electromagnetic radiation pattern of the spot beams 125. In some examples, such techniques may involve beamforming via an array of antenna elements to form one or more beamformed spot beams 125, which may include changing locations of one or more spot beams 125 over time (e.g., in accordance with a beam hopping technique over a service coverage area).

In some examples, a spot beam 125 may use or be otherwise associated with a single carrier (e.g., one frequency or a contiguous frequency range). In some examples, a spot beam 125 may be configured to support only user terminals 150, in which case the spot beam 125 may be referred to as a user spot beam or a user beam (e.g., user spot beam 125-a). For example, a user spot beam 125-a may be configured to support one or more downlink signals 172 and/or one or more uplink signals 173 between the satellite 120 and user terminals 150. In some examples, a spot beam 125 may be configured to support only access node terminals 130, in which case the spot beam 125 may be referred to as an access node spot beam, an access node beam, or a gateway beam (e.g., access node spot beam 125-b). For example, an access node spot beam 125-b may be configured to support one or more uplink signals 132 and/or one or more downlink signals 133 between the satellite 120 and access node terminals 130. In other examples, a spot beam 125 may be configured to service both user terminals 150 and access node terminals 130, and thus a spot beam 125 may support any combination of downlink signals 172, uplink signals 173, uplink signals 132, or downlink signals 133 between the satellite 120 and user terminals 150 and access node terminals 130.

A spot beam 125 may support a communications service with target devices (e.g., user terminals 150, access node terminals 130, satellites 120) that are located within a spot beam coverage area 126. A spot beam coverage area 126 may be defined by an area of the electromagnetic radiation pattern of the associated spot beam 125, as projected on the ground or other reference surface, having a signal characteristic (e.g., signal strength, signal-to-noise ratio (SNR), signal-to-interference-plus-noise ratio (SINR)) that is above or otherwise satisfies a threshold. A spot beam coverage area 126 may cover any suitable service area (e.g., circular, elliptical, hexagonal, local, regional, national) and may support a communications service with any quantity of target devices located in the spot beam coverage area 126, which may include target devices located within the associated spot beam 125, but not necessarily at the reference surface of a spot beam coverage area 126, such as airborne terminals.

In some examples, a satellite 120 may support multiple spot beams 125 each covering respective spot beam coverage areas 126, each of which may overlap or may not overlap with adjacent spot beam coverage areas 126. For example, the satellite 120 may support a service coverage area (e.g., a regional coverage area, a national coverage area) formed by the combination of any quantity (e.g., tens, hundreds, thousands) of spot beam coverage areas 126. A service coverage area may be broadly defined as a coverage area from which, and/or to which, either a terrestrial transmission source, or a terrestrial receiver may participate in (e.g., transmit and/or receive signals associated with) a communications service via the satellite 120, and may be defined by a plurality of spot beam coverage areas 126. In some systems, the service coverage area for each communications link (e.g., a forward uplink coverage area, a forward downlink coverage area, a return uplink coverage area, and/or a return downlink coverage area) may be different.

User terminals 150 may include various devices configured to communicate signals with a satellite 120, or other target device, which may include fixed terminals (e.g., ground-based stationary terminals) or mobile terminals such as terminals on boats, aircraft, ground-based vehicles, and the like. A user terminal 150 may communicate data and information via the satellite 120 or other target device, which may include communications via an access node terminal 130 to a destination device such as a network device 141, or some other device or distributed server associated with a network 140. A user terminal 150 may communicate signals according to a variety of physical layer transmission modulation and coding techniques, including, for example, those defined with the DVB-S2, WiMAX, LTE, and DOCSIS standards.

A user terminal 150 may include an antenna system 155, which may be configured for receiving downlink signals 172 (e.g., from a satellite 120), for transmitting uplink signals 173 (e.g., to a satellite 120), or both. In some examples, a user terminal 150 may be configured for uni-directional or bi-directional communications with the satellite 120 via a spot beam 125 (e.g., a user spot beam 125-a). In some implementations, an antenna system 155 may include one or more reflectors (e.g., a single reflector, a primary reflector and subreflector) and one or more antenna feeds configured to communicate (e.g., receive, transmit) signals reflected by the one or more reflectors. For example, to receive downlink signaling 172, one or more antenna feeds of an antenna system 155 may be configured to receive signals from a satellite 120 that are reflected by a reflector and, to transmit uplink signaling 173, an antenna system 155 may be configured to transmit signals from one or more antenna feeds that are reflected by a reflector towards a satellite 120. Such an antenna system 155 may be associated with a direction of peak gain (e.g., for signals reflected by the reflector, a boresight of the antenna system 155), which may be associated with a shape of the reflector (e.g., a parabolic shape, a non-parabolic shape) and geometric relationship (e.g., a spatial relationship, a relative position, a relative orientation) among the one or more antenna feeds and the one or more reflectors.

An antenna feed may refer to one or more receive antenna elements, one or more transmit antenna elements, or one or more antenna elements configured to support both transmitting and receiving (e.g., a transceiver element). A receive antenna element may include a physical transducer (e.g., an RF transducer) that converts an electromagnetic signal to an electrical signal, and a transmit antenna element may include a physical transducer that emits an electromagnetic signal when excited by an electrical signal. In some implementations, a same physical transducer may be used for transmitting and receiving. An antenna feed may include, for example, a feed horn, a polarization transducer (e.g., a septum polarized horn, which may function as two combined elements with different polarizations), a multi-port multi-band horn (e.g., dual-band 20 GHz/30 GHz with dual polarization LHCP/RHCP), a cavity-backed slot, an inverted-F, a slotted waveguide, a Vivaldi, a Helical, a loop, a patch, or any other configuration of an antenna element or combination of interconnected sub-elements. An antenna feed also may include or be otherwise coupled with an RF signal transducer, a low noise amplifier (LNA), or high power amplifier (HPA), and may be coupled with transponders for performing other signal processing.

An antenna system 155 may also include a processing system (e.g., circuits, processors, signal processors) for converting (e.g., performing frequency conversion, modulating/demodulating, multiplexing/demultiplexing, filtering, forwarding) between radio frequency (RF) communication signals (e.g., downlink signals 172 and/or uplink signals 173), and user terminal communications signals 157 communicated between the antenna system 155 and a user terminal controller 158. Such a processing system may be included in an antenna system 155, which may be referred to as an integrated antenna assembly or processor-integrated antenna assembly. Additionally, or alternatively, a user terminal controller 158 may include a processing system for performing various RF signal operations (e.g., receiving, performing frequency conversion, modulating/demodulating, multiplexing/demultiplexing, measuring signal quality, etc.). An antenna system 155 may also include various hardware for mounting or orienting one or more portions of the antenna system 155. In some examples, an antenna system 155 may be known as an outdoor unit (ODU), and a user terminal controller 158 may be known as an indoor unit (IDU).

A user terminal 150 may be connected via a wired or wireless connection 161 to one or more instances of consumer premises equipment (CPE) 160, and may provide network access service (e.g., access to a network 140, access to a network device 141, Internet access) or other communication services (e.g., broadcast media) to CPEs 160 via devices of the communication system 100. The CPE(s) 160 may include user devices such as, but not limited to, computers, local area networks, internet appliances, wireless networks, mobile phones, personal digital assistants (PDAs), other handheld devices, netbooks, notebook computers, tablet computers, laptops, display devices (e.g., TVs, computer monitors), printers, and other devices. The CPE(s) 160 may also include any equipment located at a premises of a subscriber, including routers, firewalls, switches, private branch exchanges (PBXs), Voice over Internet Protocol (VoIP) gateways, and other equipment. In some examples, a user terminal 150 may provide for two-way communications between the CPE(s) 160 and network(s) 140 via a satellite 120 and an access node terminal(s) 130.

An access node terminal 130 may service uplink signals 132 and downlink signals 133 (e.g., to and from a satellite 120). Access node terminals 130 may also be known as ground stations, gateways, gateway terminals, or hubs. An access node terminal 130 may include an access node terminal antenna system 131 and an access node controller 135. An access node terminal antenna system 131 may be two-way capable and designed with adequate transmit power and receive sensitivity to communicate reliably with one or more satellites 120. In some examples, an access node terminal antenna system 131 may comprise a parabolic reflector with high directivity in the direction of a satellite 120 and low directivity in other directions. An access node terminal antenna system 131 may be implemented in accordance with various configurations and may include operating features such as high isolation between orthogonal polarizations, high efficiency in operational frequency bands, low noise, and other features.

In some examples, an access node terminal 130 (e.g., an access node controller 135) may schedule traffic with (e.g., to, from) user terminals 150. Additionally, or alternatively, such scheduling may be performed in other parts of communication system 100 (e.g., at one or more network devices 141, which may include network operations centers (NOC) or gateway command centers). A satellite 120 may communicate with an access node terminal 130 by transmitting downlink signals 133 or receiving uplink signals 132 via one or more spot beams 125 (e.g., an access node spot beam 125-b, which may be associated with a respective access node spot beam coverage area 126-b). An access node spot beam 125-b may, for example, support a communications service for one or more user terminals 150 (e.g., relayed by the satellite 120), or any other communications between a satellite 120 and an access node terminal 130.

An access node terminal 130 may provide an interface between a network 140 and a satellite 120, and may be configured to receive information directed between the network 140 and one or more user terminals 150. An access node terminal 130 may format the data and information for delivery to respective user terminals 150. Additionally, or alternatively, an access node terminal 130 may be configured to receive signals from a satellite 120 (e.g., from one or more user terminals 150) directed to a destination accessible via a network 140. An access node terminal 130 may also format the received signals for transmission on a network 140.

The network(s) 140 may be any type of network and can include, for example, the Internet, an Internet Protocol (IP) network, an intranet, a wide-area network (WAN), a metropolitan area network (MAN), a local-area network (LAN), a virtual private network (VPN), a virtual LAN (VLAN), a fiber optic network, a hybrid fiber-coax network, a cable network, a public switched telephone network (PSTN), a public switched data network (PSDN), a public land mobile network, or any other type of network supporting communications between devices as described herein. Network(s) 140 may include both wired and wireless connections as well as optical links. Network(s) 140 may connect the access node terminal 130 with other access node terminals that may be in communication with the satellite 120 or with other satellites. One or more network device(s) 141 may be coupled with the access node terminal 130 and may control aspects of the communication system 100. In various examples a network device 141 may be co-located or otherwise nearby the access node terminal 130, or may be a remote installation that communicates with the access node terminal 130 or network(s) 140 via wired or wireless communications link(s).

In some cases, a direction of peak gain of an antenna system 155 may be misaligned with a satellite 120, resulting in signal quality that is lower than a capability of the antenna system 155. For example, an imprecise installation of an antenna system 155, movement of the antenna system 155 or components thereof (e.g., due to external forces affecting the antenna system 155, such as environmental conditions), or movement of a satellite 120 may cause a direction of peak gain of the antenna system 155 to become misaligned with a direction of the satellite 120. Misalignment between a direction of peak gain of the antenna system 155 and the satellite 120 may result in relatively inefficient communication or signaling performance via the antenna system 155, which may adversely affect throughput or efficiency of the communication system 100.

In accordance with examples as disclosed herein, an antenna system 155 may include an antenna feed positioning mechanism configured to displace at least one antenna feed relative to a reflector of the antenna system 155 along multiple dimensions (e.g., along a non-linear path), which may be implemented using a single drive interface for driving the displacement (e.g., using a single actuator, such as a motor, a wrench, a screwdriver, or other tool). Displacing an antenna feed relative to a reflector may change a direction of peak gain of an antenna system 155 (e.g., a direction of peak gain relative to the reflector) without repositioning the reflector, which may improve signal gain along a direction toward a satellite 120 without moving or reorienting the entire antenna system 155, for example. Improving the signal quality based on displacing the antenna feed may improve a communications link between an antenna system 155 and a satellite 120 (e.g., for receiving downlink signals 172, for transmitting uplink signals 173, or both), thereby reducing resource usage of communications using the antenna system and improving efficiency of the communication system 100. Further, the described techniques for an antenna feed positioning mechanism may be implemented with relatively low cost and low complexity, and may support techniques for periodic or event-driven realignments (e.g., implementing a controller of the antenna system).

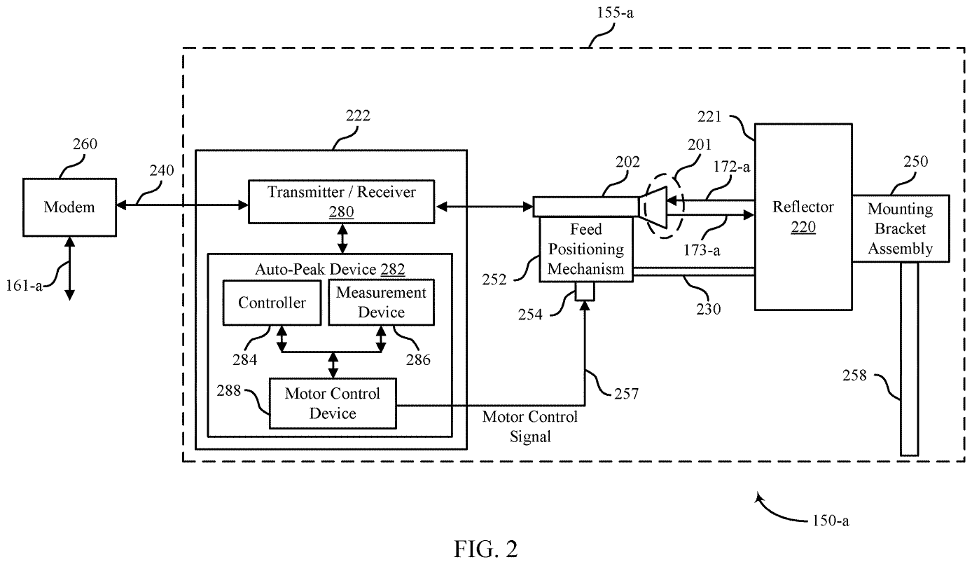

FIG. 2 shows a block diagram of a user terminal 150-a that supports techniques for peaking reflector antennas in accordance with examples as disclosed herein. The user terminal 150-a includes an antenna system 155-a, which may be configured as a reflector antenna that includes a reflector 220 and a feed 202 (e.g., an antenna feed, a feed element) that may receive or transmit signals via a surface 221 of the reflector 220. The antenna system 155-a also includes a feed positioning mechanism 252 that is configured for displacing the feed 202 relative to the reflector 220 (e.g., along a non-linear path, along at least two dimensions). Although the example of antenna system 155-a includes a single reflector 220 and a single feed 202, the described techniques may be implemented in an antenna system 155 having any quantity of one or more reflectors 220 and any quantity of one or more feeds 202.

A surface 221 may include one or more electrically conductive materials that reflect electromagnetic energy, such as signals to or from the feed 202. A shape of a surface 221 may be designed to define or be otherwise associated with a focal region 201 (e.g., a focal point, a focal area, a focal volume). In some examples, a feed 202 may be nominally (e.g., initially) positioned within a focal region 201, such that the feed 202 may interact with the surface 221 to produce a beam directed toward a satellite 120 or other target device. A focal region 201 may be a volume within which a surface 221 causes electromagnetic energy to converge sufficiently to permit signal communication having desired performance characteristics, if an incident beam (e.g., a plane wave) is received from a direction of a satellite 120. Reciprocally, a surface 221 may reflect electromagnetic energy originating from a feed 202 at a location within a focal region 201 such that the reflected electromagnetic energy is aligned along a direction of a satellite 120 sufficiently to permit signal communication having desired performance characteristics (e.g., while partially or completely cancelling out in all other directions).

A feed 202 may interact with a surface 221 to produce a beam for transmission of an uplink signal 173, for reception of a downlink signal 172, or both. For example, a downlink signal 172 from a satellite 120 (e.g., a volume of signal energy transmitted by a satellite 120) may be focused by the surface 221 and received by the feed 202 positioned within the focal region 201. Additionally, or alternatively, an uplink signal 173 from the feed 202 (e.g., a volume of signal energy transmitted by the feed 202) may be reflected by the surface 221 to focus the uplink signal 173 along a direction of the satellite 120. A feed 202 may communicate an uplink signal 173 and a downlink signal 172 with a transceiver 222 to provide for bi-directional communication with a satellite 120. In some examples, a transceiver 222 may be located in the antenna system 155-a. In some other examples, a transceiver 222 may be located in a different location that is not within the antenna system 155 (e.g., another portion of the user terminal 150-a).

A transceiver 222 may include a receiver within a transmitter/receiver 280 that can amplify and down-convert a downlink signal 172 received via the feed 202 to generate an intermediate frequency (IF) receive signal (e.g., of signals 157) for delivery to a modem 260. Additionally, or alternatively, a transceiver 222 may include a transmitter within transmitter/receiver 280 that can upconvert and amplify an IF transmit signal (e.g., of signals 157) received from the modem 260 for transmission of an uplink signal 173 via the feed 202. For some examples in which a satellite 120 operates in a multiple beam mode, the frequency ranges or the polarizations of the uplink signal 173 and the downlink signal 172 may be different for different spot beams 125. Thus, the antenna system 155-a may be within the spot beam coverage area 126 of one or more spot beams 125 and, in some examples, a transceiver 222 may be configurable to match a polarization and a frequency range of a particular spot beam 125. In some examples, a modem 260 may be located inside a structure to which the antenna system 155-a is attached (e.g., in another portion of the user terminal 150-a, such as a user terminal controller 158). In some other examples, a modem 260 may be located in an antenna system 155, such as being incorporated within a transceiver 222.

In the example of antenna system 155-a, the transceiver 222 may communicate an IF receive signal and an IF transmit signal with the modem 260 via IF/DC cabling 240 that, in some examples, may also be used to provide DC power to the transceiver 222. In some other examples, a transceiver 222 and a modem 260 may, for example, communicate the IF transmit signal and IF receive signal wirelessly or optically. A modem 260 may modulate and demodulate the IF receive and transmit signals, respectively, to communicate data with a router (not shown). The router may route the data among one or more end user devices (e.g., CPE 160, not shown), such as laptop computers, tablets, mobile phones, etc., to provide bidirectional data communications, such as two-way Internet or telephone service.

The antenna system 155-a may also include a mounting bracket assembly 250 for adjusting a direction, positioning, or orientation of the antenna system 155-a (e.g., for a nominal alignment, for an initial alignment, for alignment of at least the reflector 220 relative to a target). For example, the mounting bracket assembly 250 may be adjusted to change the direction of at least the reflector 220 to direct a beam of the antenna system 155-a along a direction toward a satellite 120 or other target. In some examples, the mounting bracket assembly 250 may be configured to collectively align the reflector 220 and the feed 202 along a nominal orientation (e.g., a nominal system orientation, a nominal reflector orientation), which may include moving a structure that includes at least the reflector 220, the feed 202, and a structure 230 (e.g., a boom arm) between the reflector 220 and the feed 202 (e.g., between the reflector 220 and a feed positioning mechanism 252). For example, the mounting bracket assembly 250 may be attached to the back of the reflector 220, or to the structure 230 (e.g., a structure coupled between the reflector 220 and the feed positioning mechanism 252).

In the example of antenna system 155-a, the mounting bracket assembly 250 is attached to a mast 258 which, in turn, may be attached to a stationary structure (e.g., ground, a building or other structure, not shown). The mounting bracket assembly 250 may be configured to support azimuth (e.g., an angle between a centerline of the reflector 220 and a direction of true north in a horizontal plane), elevation (e.g., an angle between the centerline of the reflector 220 and the horizon) and skew (e.g., an angle of rotation about the centerline of the reflector 220) adjustments of the antenna system 155-a (e.g., of at least the reflector 220, for collectively orienting a structure that includes the reflector 220, the structure 230, the feed positioning mechanism 252, and the feed 202) relative to the mast 258. The mounting bracket assembly 250 may, for example, include bolts that can be loosened to permit at least a portion of the antenna system 155-a being moved in azimuth, elevation, and skew. After positioning the antenna 210 to the desired position in one of azimuth, elevation, and skew, the bolts for that portion of the mounting bracket assembly 250 may be tightened and other bolts loosened to permit a second adjustment being made.

In some examples, an installer may use the mounting bracket assembly 250 to coarsely point the beam of the antenna system 155-a along a direction generally towards a satellite 120 or other target. A coarse pointing may have a directional error (e.g., due to manual pointing accuracy limitations), which may result in a gain of the antenna system 155-a along the direction of the satellite 120 being less than a gain capability of the antenna system 155-a. An installer may use a variety of techniques to coarsely point the beam of the antenna system 155-a toward the satellite 120. For example, initial azimuth, elevation and skew angles for pointing the beam of the antenna system 155-a may be determined by the installer based on the known location of a satellite 120 and a known geographic location of the antenna system 155. For implementations in which the surface 221 is not symmetric about the boresight axis and, correspondingly, has major and minor beamwidth values in two planes, the installer can adjust the skew angle of the mounting bracket assembly 250 until the major axis of the surface 221 (the longest line through the center of the reflector 220) is aligned with a geostationary arc of the satellite 120. After the beam of the antenna system 155-a has been initially pointed along the general direction of the satellite 120, the elevation or azimuth angles can be further adjusted by the installer until the beam of the antenna system 155-a is sufficiently pointed toward the satellite 120.

In some cases, a beam of the antenna system 155-a may be coarsely pointed based on signal strength of a signal received from a satellite 120 via a feed 202, such as a downlink signal 172. In some other cases, a beam of the antenna system 155-a may be coarsely pointed based on information in the received signal indicating the signal strength of a signal received by a satellite 120 from the antenna system 155-a, such as an uplink signal 173. For cases in which a strength of a signal received from the satellite 120 is used, a measurement device, such as a power meter, may be used to directly measure the signal strength of the received signal. Additionally, or alternatively, a measurement device may be used to measure some other metric indicating signal quality of the received signal. A measurement device may, for example, be an external device that an installer temporarily attaches to a feed 202 or other portion of the antenna system 155-a. In some other examples, a measurement device may be incorporated into a transceiver 222, such as a measurement device 286 of an auto-peak device 282. In such examples, the measurement device 286 may produce audible tones or other indication of signal strength to assist the installer in pointing the beam of the antenna system 155-a. The installer can then iteratively adjust the elevation, azimuth, or skew angle (e.g., of the mounting bracket assembly 250, of the antenna system 155-a) until the received signal strength (or other metric), as measured by the measurement device 286, reaches a predetermined value (e.g., a threshold signal quality).

When a beam of the antenna system 155-a is sufficiently pointed along a direction toward a satellite 120 (e.g., within a threshold signal quality, within a coarse alignment threshold), the installer can immobilize the mounting bracket assembly 250 to preclude further movement of the beam by the mounting bracket assembly 250 (e.g., fixing a position between the mast 258 and at least the reflector 220). Then, a feed positioning mechanism 252 may be used to fine tune the direction of the beam of the antenna system 155-a to point the beam more accurately along the direction of the satellite 120 (e.g., to reduce the pointing error). For example, the feed positioning mechanism 252 may be operable to adjust a direction, positioning, or orientation of the feed 202 relative to the reflector 220 (e.g., relative to the structure 230, adjusting a signaling volume or axis of symmetry thereof associated with the feed 202). In some examples, the feed positioning mechanism 252 may be configured to adjust a direction of peak gain of the antenna system 155-a (e.g., a boresight direction of the antenna system 155-a) without moving the reflector 220, which may involve pointing a direction of peak gain of the feed 202 toward a different location on the surface 221, or along a different angle relative to the reflector 220 (e.g., a different angle of incidence with the surface 221), or a combination thereof.

A feed positioning mechanism 252 may be driven by a motor 254 or other actuator (e.g., a tool, such as a wrench or a driver) which may, in some examples, actuate (e.g., drive, rotate) a single drive interface of the feed positioning mechanism 252. For example, driving the motor 254 may displace the feed 202 along a path of at least two dimensions (e.g., a non-linear path) relative to the reflector 220, which may provide a fine tuning of the direction of the beam of the antenna system 155-a. Additionally, or alternatively, an installer may position (e.g., temporarily) a driver on the drive interface to actuate the feed positioning mechanism 252, in which case a motor 254 may be omitted). In some examples, such a path of the feed 202 may be implemented as a hypotrochoid pattern or other pattern, which may be within a plane that is perpendicular to a direction of peak gain (e.g., a nominal signaling axis) of the feed 202. The feed positioning mechanism 252 may be designed such that a greatest map angle of the beam between successive portions (e.g., path portions, petals, rotations) of the pattern is relatively small compared to the beamwidth of the beam of the antenna system 155-a (e.g., less than a 1-dB beamwidth of the beam), which may provide for a location along the path at which the beam of the antenna system 155-a will be sufficiently finely pointed at the satellite 120. In some implementations, a feed positioning mechanism 252 may include a gear assembly or other mechanism that, in response to actuation by a motor 254 or other implement, causes the feed 202 to be displaced relative to the reflector 220 without displacing the reflector 220 itself.

In some implementations, an auto-peak device 282 may be incorporated in the transceiver 222 and configured to perform a fine tuning operation for aligning a beam of the antenna system 155-a using the feed positioning mechanism 252. For example, the auto-peak device 282 may include a controller 284, a measurement device 286, and a motor control device 288. The controller 284, the measurement device 286, or the motor control device 288, among other components (e.g., a modem 260, a transmitter/receiver 280) or any combination thereof may be referred to as of be included in a processing system associated with operations of the antenna system 155-a, at least a portion of which may be configured to cause the user terminal 150-a (e.g., the antenna system 155-a) to perform one or more of the techniques described herein.

For example, a controller 284 may control operation of a measurement device 286, or a motor control device 288, or both to perform the fine tuning operation of the beam via the feed positioning mechanism 252 using the techniques described herein. A controller 284 may be operable to receive a command (e.g., via a downlink signal 172, via signals 157, via signals 161-a, by a command or instruction from an installer) to begin the fine tuning operation of the beam of the antenna 210 (e.g., after completion of a coarse pointing operation), or based on signal conditions (e.g., if a signal quality or communications quality does not satisfy a threshold). In some cases, a command may be transmitted (e.g., via a downlink signal 172) after initial entry of the user terminal 150 into the network, or may be received from equipment (e.g., a cell phone, laptop) of the installer. In some examples, such a command may be transmitted to multiple user terminals 150 (e.g., concurrently, as a broadcast command), such as a command transmitted to multiple user terminals 150 located in a portion (e.g., a sector) of a service coverage area. In some cases, the fine tuning operation may be initiated on a periodic basis (e.g., a daily basis, such as during evenings or other relatively inactive period, a weekly basis, a monthly basis, a yearly basis), which may be determined at user terminals 150 or by an administrative entity of the communication system 100 (e.g., by a network device 141, for transmitting individual commands to respective user terminals 150, for transmitting broadcast commands to multiple user terminals 150).

During a fine tuning operation, a motor control device 288 can provide a motor control signal on a line 257 to the motor 254 to drive the feed positioning mechanism 252. In some examples, such a signal may be an on/off signal (e.g., via an on/off switch of or controlled by the motor control device 288). Driving the feed positioning mechanism may move the feed 202 to various positions relative to the reflector which, in turn, may change a direction of peak gain relative to the reflector 220. A measurement device 286 may measure the received signal strength at the various positions (e.g., using a power meter). After displacing the feed 202 along a path (e.g., along a hypotrochoid or other pattern, after a sweep of at least some of if not all of the pattern), the controller 284 may select a position for the feed 202 (e.g., corresponding to a direction of the beam of the antenna system 155-a) based on the measured signal quality (e.g., a position corresponding to the peak signal strength measured). The controller 284 can then command the motor control device 288 to provide the motor control signal to drive the motor 254 to displace the feed 202 to the selected position, after which the motor 254 may hold the feed at the selected position (e.g., in accordance with a self-locking motor-gear head, in accordance with a clutch feature). In various examples, such techniques may implement an encoder (e.g., of or coupled with a motor 254), or may implement signal processing techniques for determining a signal quality pattern based on the sweep along the path that is followed by using the signal quality pattern to return the feed 202 to a desired position along the path.

The auto-peak device 282 may be used to fine tune the direction of the beam of the antenna system 155-a (e.g., during installation of the antenna system 155-a). In some implementations in which the auto-peak device 282 is included in the antenna system 155-a, the auto-peak device 282 may also be used to fine tune pointing of the beam of the antenna system 155-a after installation (e.g., periodically, based on an initiating condition). For example, after the antenna system 155-a has been installed and is in use, the auto-peak device 282 may enable the beam of the antenna system 155-a to be periodically fine-tuned without a technician being present at the installation location of the antenna system 155. The auto-peak device 282 may, for example, automatically perform a fine-tuning operation using the feed positioning mechanism 252.

In some cases, the auto-peak device 282 may perform a pointing operation in response detecting a performance degradation that could be caused by a change in the direction of the beam, a change in location of a satellite 120, or a combination thereof. The manner in which a performance degradation is detected and the auto-peak device 282 initiates the pointing operation may vary. In some examples, the auto-peak device 282 may include a memory device for storing one or more signal strengths measured by the measurement device 286 during installation, and may compare that stored measured signal strength to a current measurement made by the measurement device 286. The auto-peak device 282 may then initiate the pointing operation if the difference between the current measured signal strength and the stored measured signal strength exceeds a threshold.

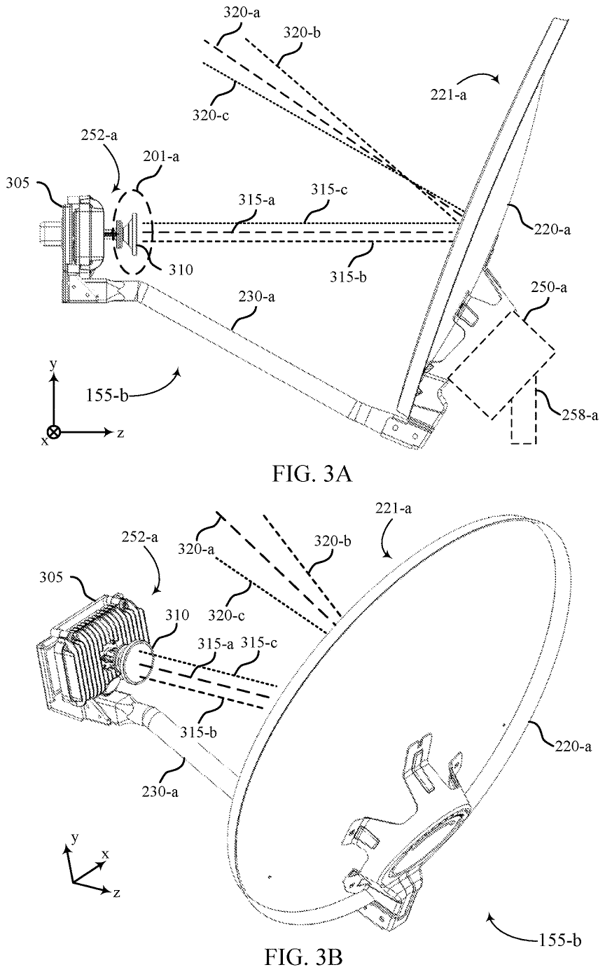

FIGS. 3A and 3B show an example of an antenna system 155-b that supports techniques for peaking reflector antennas in accordance with examples as disclosed herein. For example, FIG. 3A illustrates the antenna system 155-b as a side-view along an x-direction (e.g., in a yz-plane), and FIG. 3B illustrates the antenna system 155-b in a diagonal view (e.g., a trimetric view). The antenna system 155-b includes a reflector 220-a, and a signaling assembly 305 (e.g., a transmit/receive integrated assembly (TRIA)), which may include at least an antenna feed assembly 310 (e.g., including one or more feeds 202, associated with a signaling volume for signaling to the antenna feed assembly 310, from the antenna feed assembly 310, or both). In some implementations, a signaling assembly 305 may include other components, such as one or more components of a transceiver 222, a modem 260, or a combination thereof. The signaling assembly 305 may be coupled with the reflector 220-a via a structure 230-a. Although the example of antenna system 155-b illustrates an offset-fed antenna, the described techniques may also be implemented in a center-fed antenna. The antenna system 155-b (e.g., a portion of the signaling assembly 305) may be configured to displace the antenna feed assembly 310 (e.g., relative to the reflector 220-a, relative to the structure 230-a, relative to a body of the signaling assembly 305) to support fine tuning of a beam communicated between the antenna system 155-b and a satellite 120 or other target device.

The antenna system 155-b may be configured for communications via signaling reflected off the reflector 220-a. For example, the antenna feed assembly 310 may be configured for signaling along a feed axis 315, which may refer to a direction of peak signal gain (e.g., transmit gain, receive gain, or both) associated with the antenna feed assembly 310, an axis of symmetry (e.g., rotational symmetry, reflective symmetry) of signal propagation associated with the antenna feed assembly 310 (e.g., an axis of symmetry of a signaling volume associated with the antenna feed assembly 310, a centerline of the antenna feed assembly 310), or both (e.g., of one or more feeds 202 of the antenna feed assembly 310, an axis centered with the antenna feed assembly and aligned along the z-direction). Based on the geometry of the reflector 220-a (e.g., a shape of the surface 221-a), and a location and alignment of the antenna feed assembly 310 relative to the reflector 220-a, a feed axis 315 may be associated with a corresponding boresight 320, which may refer to a direction of peak signal gain associated with the antenna system 155-b. Thus, the surface 221-a of the reflector 220-a may be configured to redirect signaling between a target along a boresight 320 and the antenna feed assembly 310 along a feed axis 315.

For example, in a nominal (e.g., initial, central, origin) position of the antenna feed assembly 310, for signal transmission, the antenna feed assembly 310 may transmit signaling toward the reflector 220-a along the feed axis 315-a, and the signaling may be reflected off the surface 221-a of the reflector 220-a along a direction of the boresight 320-a. Alternatively, for signal transmission reception, the reflector 220-a may receive incident signaling (e.g., from a satellite 120) along the boresight 320-a that is redirected along a direction of the feed axis 315-a to the antenna feed assembly 310. In some examples, the feed axis 315-a and the boresight 320-a may be associated with a highest gain capability of the antenna system 155-b (e.g., in accordance with a geometric optimum), such that the antenna feed assembly 310 is located at a focal point or a middle of a focal region (e.g., a focal region 201-a) of the reflector 220-a. In such examples, a highest possible signal quality may be achieved when a target is aligned with the boresight 320-a.

In some cases, the antenna system 155-b may be mounted in a generally stationary manner (e.g., via a mounting bracket assembly 250-a and a mast 258-a). The mounting bracket assembly 250-a may be configured to adjust an orientation of the antenna system 155-b (e.g., the boresight 320-a) relative to the object, such that, an installer (e.g., technician) may perform coarse tuning adjustments via the mounting bracket assembly 250-a. In some implementations, the antenna system 155-b (e.g., the signaling assembly 305) may include or be coupled with (e.g., permanently, temporarily) a measurement device 286 configured to measure signal characteristics of a signal communicated between the antenna system 155-b and a satellite 120 and indicate the signal characteristics to the installer (e.g., as described with reference to FIG. 2). In some examples, the installer may use the measured signal characteristics to perform coarse adjustments by identifying an orientation of the antenna system 155-b (e.g., of the reflector 220-a, the structure 230-a, the signaling assembly 305, or a combination thereof) with peak gain or with one or more signal characteristics that satisfy a threshold.

Installing the antenna system 155-b and performing coarse alignment adjustments may align the antenna system 155-b (e.g., the boresight 320-a) with a satellite 120 within a threshold quality, but may not result in a peak quality of a signal communicated between the antenna system 155-b and the satellite 120 (e.g., due to manual inaccuracies of installing the antenna system 155-b). Further, in some cases after performing alignment adjustments, an orientation of the antenna system 155-b may change (e.g., due to degradation of one or more components, based on external forces applied to the antenna system 155-b, to the mounting bracket assembly 250-a, or to the mast 258-a, among other factors). For example, over time, environmental conditions may alter the orientation (e.g., droop, drift) of the antenna system 155-b (e.g., of the boresight 320-a), thereby causing the alignment of peak gain of the antenna system 155-b to deviate from a direction of a target device. In some such cases, a technician may be allocated to realign the antenna system 155-b (e.g., to realign the boresight 320-a along a direction of the satellite), thereby incurring maintenance costs to support the operation of the antenna system 155-b.

To support improved alignment capabilities, the antenna system 155-b (e.g., the signaling assembly 305) may include a feed positioning mechanism 252-a that supports fine tuning adjustments that facilitate alignment of a boresight 320 (e.g., an adjusted boresight 320) with a target device, such as a satellite 120. The signaling assembly 305 may be configured to displace (e.g., translate, reposition) the antenna feed assembly 310 relative to the reflector 220-a (e.g., relative to the structure 230-a, relative to a body of the signaling assembly 305, which may fixed by the mounting bracket assembly 250-a), such as a displacement within a plane that is perpendicular to a direction of peak signal gain of the antenna feed assembly 310 (e.g., perpendicular to a feed axis 315, within an xy-plane). For example, the feed positioning mechanism 252-a may be operable to move the antenna feed assembly 310 downward along the y-direction, which may cause the antenna feed assembly 310 to be associated with a feed axis 315-b (e.g., a displaced feed axis) and, in turn, the antenna system 155-b may be associated with a boresight 320-b (e.g., a realigned boresight 320, at a different direction of alignment than the boresight 320-a). The feed positioning mechanism 252-a may also be operable to move the antenna feed assembly 310 upward along the y-direction, which may cause the antenna feed assembly 310 to be associated with a feed axis 315-c and, in turn, the antenna system 155-b may be associated with a boresight 320-c (e.g., at a different direction of alignment than the boresight 320-a and the boresight 320-b). The feed positioning mechanism may also be operable to move the antenna feed assembly 310 along the x-direction (e.g., in accordance with a non-linear path at different positions along the x-direction and the y-direction) to support corresponding adjustments to positions of feed axes 315 (e.g., relative to the reflector 220-a) and orientations of boresights 320. Although such techniques may move a feed axis 315 away from a geometrically optimal condition, resulting in a lower gain of the antenna system 155-b, such an effect may be relatively small compared with the improved signal quality supported by aligning a boresight 320 more closely with a direction of a target, thereby providing a net gain by such fine-tuning.

In some examples, the signaling assembly 305 may include a feed positioning mechanism 252-a that is configured to displace the antenna feed assembly 310 along a path in an xy-plane. For example, such a feed positioning mechanism 252-a may include a gear assembly having a drive interface (e.g., a single drive interface) that may be driven by an actuator (e.g., a single actuator, a motor 254, a driver or other tool), such that the gears of the gear assembly displace the antenna feed assembly 310 in a pattern (e.g., a hypotrochoid pattern). In some examples, a motor 254 may drive the gear assembly to produce a continuously repeating pattern such that, after finishing the hypotrochoid pattern, the gear assembly may repeat the hypotrochoid pattern. For example, a motor 254 may be configured to operate in a unidirectional manner (e.g., without reversal) and without disengaging (e.g., with continuous engagement).

In some cases, the antenna feed assembly 310 may be displaced along a path having multiple instances of a path portion (e.g., lobes, petals) that are each associated with (e.g., aligned with) a different angle about an origin (e.g., different angles in an xy-plane, different angles about the z-direction). In some examples, each path portion may include at least one return to or near such an origin, which may be associated with the feed axis 315-a (e.g., a nominal position of the antenna feed assembly 310, a location at a focal point of the reflector 220-a, a location of peak gain capability of the antenna system 155-b). In some examples, such a path may be associated with a quantity of first positions along a direction of a Cartesian coordinate system (e.g., the x-direction) relative to the reflector 220-a and, for each of the first positions, a respective quantity of second positions along a second direction of the Cartesian coordinate system (e.g., the y-direction). In some examples, the path may be associated with a quantity of angles of a polar coordinate system relative to the reflector 220-a (e.g., about the z-axis) and, for each of the angles, a respective quantity of radial positions (e.g., in an xy-plane) of the polar coordinate system. Such a pattern may be configured to be relatively denser with a higher quantity of path portions about an axis of repetition, thereby providing more mapping throughout the plane.

In some examples, a signaling assembly 305 may include a measurement device 286 (e.g., coupled with a controller 284, coupled with a motor control device 288, coupled with a modem 260, coupled with a transmitter/receiver 280, coupled with the feed positioning mechanism 252-a), and the measurement device 286 may measure signal characteristics (e.g., of a signal communicated between the antenna system 155-b and a satellite 120, of signals received by a modem 260, of signals received by a transmitter/receiver 280), including such measurements as the antenna feed assembly 310 is displaced along the path. In some examples, a controller 284 may identify a position of the antenna feed assembly 310 (e.g., in accordance with a determined signal quality pattern, in accordance with an encoder coupled with a motor 254) along the pattern having a peak signal quality, and signal an indication of the position to a motor control device 288 or to an installer (e.g., via a visual indication, via an audible indication). The feed positioning mechanism 252 may thus be used to drive the antenna feed assembly 310 (e.g., along the x-direction, along the y-direction, or a combination thereof) toward the position of peak signal quality, thereby resulting in the antenna system 155-b being configured to produce relatively highest signal quality (e.g., aligning a boresight 320 relatively closely to a direction of a satellite 120) for a given position or orientation of the antenna system 115-b (e.g., of the reflector 220-a).

In some examples, such fine tuning adjustments may be supported by a feed positioning mechanism 252 based on a detected condition (e.g., by an installer, via a network, from the satellite 120, by a controller 284), such that the fine tuning adjustments may occur during installation, maintenance, connection of the antenna system 155-b or associated user terminal 150 to a network, or after connection with a satellite 120. Additionally, or alternatively, fine tuning adjustments may be performed based on a command from an external system (e.g., from a satellite 120, from an access node controller 135, from a network device 141, as a unicast command, as a broadcast command, as a sector command). Additionally, or alternatively, fine tuning adjustments may be performed periodically, such that the feed positioning mechanism 252 may be used to perform a fine adjustment process after a threshold duration from a previous performance has been satisfied. Additionally, or alternatively, fine tuning adjustments may be performed based on identifying a signal characteristic satisfies a threshold (e.g., has dropped below an acceptable value).

In an illustrative example, the signaling assembly 305 or associated user terminal 150 may be configured to perform fine tuning adjustments based on receiving a command via a network 140. For example, a communications management system may identify a period of relatively low-use of the network, and weather conditions around the antenna system 155-b that are within an acceptable range, and initiate a fine tuning adjustment process (e.g., based on transmitting a command). The command may be received via a modem 260 or other portion of the user terminal 150 (e.g., which may include one or more processors or controllers) associated with the antenna system 155-b, and the system may transmit a signal to perform the fine tuning adjustment process (e.g., to a controller 284, to a motor control device 288). A motor 254 may be controlled to drive a drive interface of the feed positioning mechanism 252 to actuate a gear assembly, and the gear assembly may displace the antenna feed assembly 310 along a non-linear path (e.g., a hypotrochoid pattern). The modem 260 or other portion of the user terminal 150 (e.g., of the signaling assembly 305) may be configured to receive signal characteristic data from the measured for the antenna feed assembly 310 and identify a peak signal quality along the path (e.g., in accordance with a signal quality pattern while driving the feed positioning mechanism 252). The modem 260 or controller 284 may allow the motor to repeat the pattern until a peak signal quality is identified, after which the modem 260 or controller 284 may indicate the motor 254 to stop driving the feed positioning mechanism 252. In some cases, the modem 260 or controller 284 may include or be coupled with an encoder configured to identify a position along the pattern at which the peak signal quality was achieved, and the modem 260 or controller 284 may control the motor to repeat the pattern until reaching the position identified by the encoder. After the antenna feed assembly 310 reaches the position at which the peak signal quality is achieved, the antenna system 155-b may communicate with the satellite 120 via the antenna feed assembly 310.

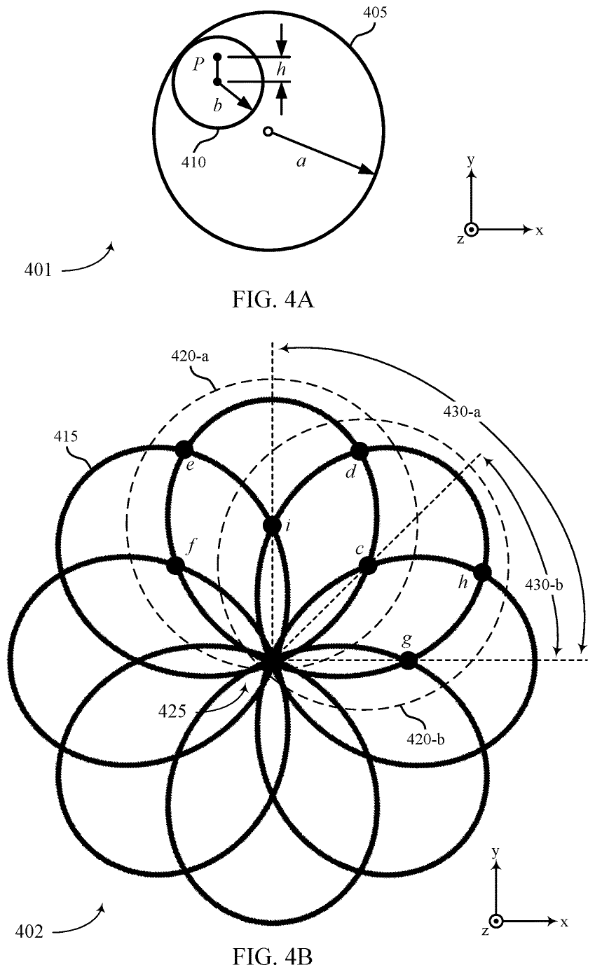

FIGS. 4A and 4B show examples of a displacement geometry diagram 401 and a displacement path diagram 402, respectively, that support techniques for peaking reflector antennas in accordance with examples as disclosed herein. Aspects of the displacement geometry diagram 401 and the displacement path diagram 402 may be described in relation to the illustrated coordinate systems, such that the displacement geometry diagram 401 and the displacement path diagram 402 are shown an xy-plane, which may correspond to the xy-plane as described with reference to FIGS. 3A and 3B. The displacement geometry diagram 401 and the displacement path diagram 402 illustrate features that support a path 415 through which a feed positioning mechanism 252 may displace an antenna feed assembly 310 relative to a reflector 220 of an antenna system 155.

The displacement geometry diagram 401 illustrates geometric relationships that may support a pattern of displacement of an antenna feed assembly 310. For example, the displacement geometry diagram 401 shows a circle 405 having a radius a and a circle 410 having a radius b. Additionally, the circle 410 may include a point P at a distance h from the center of the circle 410. By displacing and rotating the circle 410 along the diameter of the circle 405, the point P may trace a hypotrochoid pattern about a center of the circle 405, such as the path 415 of the displacement path diagram 402.

In some implementations, the circle 405 and the circle 410 may illustrate an example geometry of a gear system, which may be external to or part of an actuator (e.g., a gearmotor). For example, the circle 405 may illustrate a diameter (e.g., a reference diameter, a pitch circle) of an internal gear (e.g., a ring gear) and the circle 410 may illustrate a diameter of an external gear (e.g., a cog gear, a spur gear). Gears associated with the geometry of the circle 405 and the circle 410 may interact such that the external teeth of the gear associated with the circle 410 mesh with the internal teeth of the gear associated with the circle 405 For example, the gear associated with the circle 410 may rotate inside and along the interior of the gear associated with the circle 405. In some cases, the point P may illustrate an example location of a coupling, which may be fixed to a surface of the gear associated with the circle 410.

The displacement path diagram 402 approximates an example of the resulting path 415 of the point P for a certain geometry of the circle 405, the circle 410, and the distance h (e.g., as a gear associated with circle 410 is driven within a gear associated with the circle 405). For example, as the gear associated with the circle 410 rotates along the internal edge of the gear associated with the circle 405, the point P may translate along the path 415 shown in the displacement path diagram 402. In some examples, the point P may start at point 425 (e.g., an origin), and travel along a path portion 420 before returning to the point 425. For example, the point P may travel from point 425 to point c, from point c to point d, from point d to point e, from point e to point f, and from point f to point 425 as part of a path portion 420-a (e.g., associated with an angle 430-a about the z-axis or point 425). The point P may also (e.g., subsequently) travel from point 425 to point g, from point g to point h, from point h to point d, from point d to point i, and from point i to point 425 as part of a path portion 420-b (e.g., associated with an angle 430-b about the z-axis). Thus, each path portion 420 may be associated with a respective angle 430 about the z-axis (e.g., about the point 425). Although each path portion 420 is illustrated as returning to the point 425, in some other examples, a path portion 420 may not return precisely to an origin, but may return within a threshold distance of the point 425 (e.g., substantially returning to an origin, returning within a threshold distance of a geometrically optimal position relative to a reflector 220).

A resulting path 415 of a point P may be mapped in accordance with Equations 1 and 2 as follows:

$$x ( θ ) = ( a - b ) * cos ( θ ) + h * cos ( \frac{a - b}{b} * θ ) \qquad ( 1 )$$

$$y ( θ ) = ( a - b ) * sin ( θ ) + h * sin ( \frac{a - b}{b} * θ ) \qquad ( 2 )$$

where the values of a, b, and h may refer to the quantities illustrated in the displacement geometry diagram 401, and θ may refer to the angle about the z-axis of the center of the circle 410 relative to the center of the circle 405.

The resulting path 415 of point P illustrates a displacement pattern that may be implemented for displacing an antenna feed assembly 310 as an feed positioning mechanism 252 is actuated. For example, a coupling associated with the point P may be coupled with the antenna feed assembly 310, such that the antenna feed assembly 310 (e.g., one or more feeds 202) may follow the path 415 of point P relative to a reflector 220. Thus, an antenna feed assembly 310 may be displaced along a path of at least two dimensions (e.g., a non-linear path), associated with the x-direction and y-direction of the illustrated coordinate systems.

In some implementations, the antenna feed assembly 310 may be driven along the path 415 to determine a position of peak signal quality along the path 415. For example, the feed positioning mechanism 252 may drive the antenna feed assembly 310 along the path 415 (e.g., associated with different displacements of a feed axis 315) while signal characteristics are measured via the antenna feed assembly 310 (e.g., by a measurement device 286, to generate a signal quality pattern). A controller 284 or other component may identify a peak signal quality while the antenna feed assembly 310 is driven along the path 415 (e.g., in its entirety), and the feed positioning mechanism 252 may be driven to repeat at least a portion of the path 415 until reaching the position at which the signal quality peaked. For example, during a first pass along the path 415, a peak signal gain may be identified when the antenna feed assembly 310 is located at a position between the point c and the point d. Thus, in another pass through a portion of the path 415, the feed positioning mechanism 252 may be driven and stop when the antenna feed assembly 310 is located at the position between the point c and the point d.

In some cases, a pattern density of a path 415 may be configured in accordance with a scan resolution of an antenna system 155, and may be associated with a quantity of path portions 420 included in the path 415. For example, the density of the pattern shown in FIG. 4B is defined by eight path portions 420. However, the density of the pattern may be increased or decreased based on increasing a quantity of path portions 420 or decreasing a quantity of path portions 420, respectively. In some cases, setting a relatively higher scan resolution may result in a denser pattern, and therefore a greater quantity of path portions 420. For example, a density of the pattern may affect the magnitude of an angle (e.g., of a boresight 320) between the path portions 420 (e.g., about the z-axis), such that a denser pattern may result in a smaller angle between the path portions 420. However, setting a relatively lower scan resolution may result in a less dense pattern, and therefore a lower quantity of path portions 420. In some such cases, a higher scan resolution may be associated with a relatively longer time to complete a fine adjustment of the antenna feed assembly 310, whereas a lower scan resolution may be associated with a relatively shorter time to complete fine adjustment of the antenna feed assembly 310.

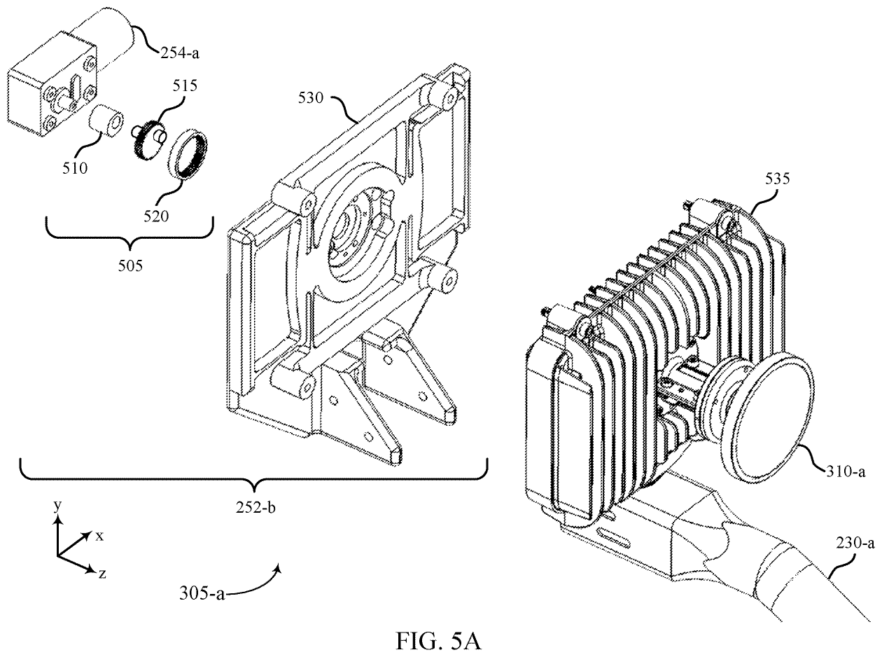

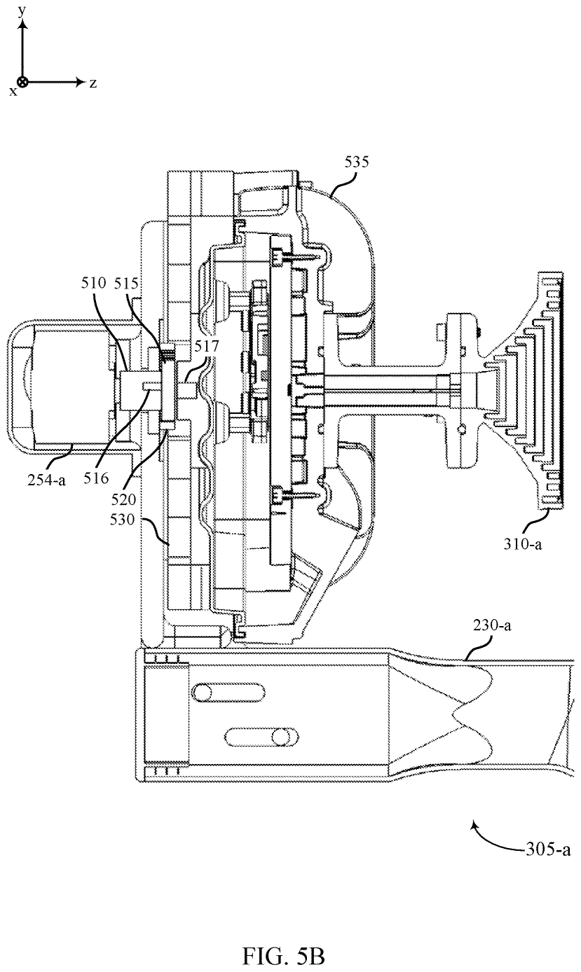

FIGS. 5A and 5B show an example of a signaling assembly 305-a that supports techniques for peaking reflector antennas in accordance with examples as disclosed herein. For example, FIG. 5A illustrates the signaling assembly 305-a from a diagonal exploded view, and FIG. 5B illustrates the signaling assembly 305-a as a cross-sectional view in a yz-plane, where features of the signaling assembly 305-a may extend for some distance along the x-direction (e.g., into or out of the page).

The signaling assembly 305-a may include one or more structures configured with a fixed coupling relative to a reflector 220 (e.g., relative to a structure 230-a), one or more structures configured with a fixed coupling relative to the antenna feed assembly 310-a, and a mechanism configured to translate the structures in response to actuation received via a drive interface, such as an actuation from a motor 254-a. For example, the signaling assembly 305-a includes an antenna feed assembly 310-a, which may be configured to receive and transmit signaling with a gain that is at least partially based on a location of the antenna feed assembly 310-a in an xy-plane. The signaling assembly 305-a also includes feed positioning mechanism 252-b with a mechanism 505 (e.g., a gear assembly, a kinematic assembly) configured to displace at least the antenna feed assembly 310-a along a path (e.g., a path 415) relative to a reflector 220 in the xy-plane. The mechanism 505 includes a drive coupling 510, a cog gear 515 (e.g., an external gear), and a ring gear 520 (e.g., an internal gear), which may interact to form a path 415. In some examples, the signaling assembly 305-a may include a motor 254-a that is operable to actuate the mechanism 505 (e.g., via a drive interface of the drive coupling 510). Although the mechanism 505 is illustrated as being external to the motor 254-a, in some other examples, a mechanism 505 (e.g., the drive coupling 510, the cog gear 515, and the ring gear 520), or other mechanism that supports the described techniques, may be integrated with a motor 254 (e.g., as a single drive assembly, as a gear motor, as a hypotrochoid gear motor).

The signaling assembly 305-a also includes a flexure 530 (e.g., including one or more compliant members) configured to constrain the antenna feed assembly 310-a and the mechanism 505 with a signaling assembly housing 535, while still allowing for movement of at least the antenna feed assembly 310-a relative to a reflector 220 using the mechanism 505. The signaling assembly housing 535 may be mounted to a structure 230-b via the flexure 530, which may be connected to a reflector 220 (not shown). In the illustrated example, the mechanism 505 may be configured to collectively displace the antenna feed assembly 310-a (e.g., in accordance with the antenna feed assembly 310-a being fixed relative to the signaling assembly housing 535). However, in some other examples, the signaling assembly housing 535 may be fixed relative to the reflector 220, and the mechanism 505 may be configured to displace the antenna feed assembly 310-a relative to the signaling assembly housing 535 (e.g., in accordance with one or more degrees of freedom between the antenna feed assembly 310-a and the signaling assembly housing 535).

The mechanism 505 may displace the antenna feed assembly 310-a based on the drive coupling 510 being driven by the motor 254-a, or other implement (e.g., actuator, driver, tool). The drive coupling 510 may be coupled with the cog gear 515 such that the rotation of the drive coupling 510 may rotate the cog gear 515 within the ring gear 520. For example, the cog gear 515 may include an interface 516 (e.g., a pin, a rotational interface) operable to couple with the drive coupling 510. Additionally, the cog gear 515 may include an interface 517 (e.g., a pin, a rotational interface) operable to couple with the antenna feed assembly 310-a. The displacement of the interface 517 during rotation of the motor 254-a may form a pattern of displacement for the antenna feed assembly 310-a (e.g., in an xy-plane), such as a hypotrochoid pattern.

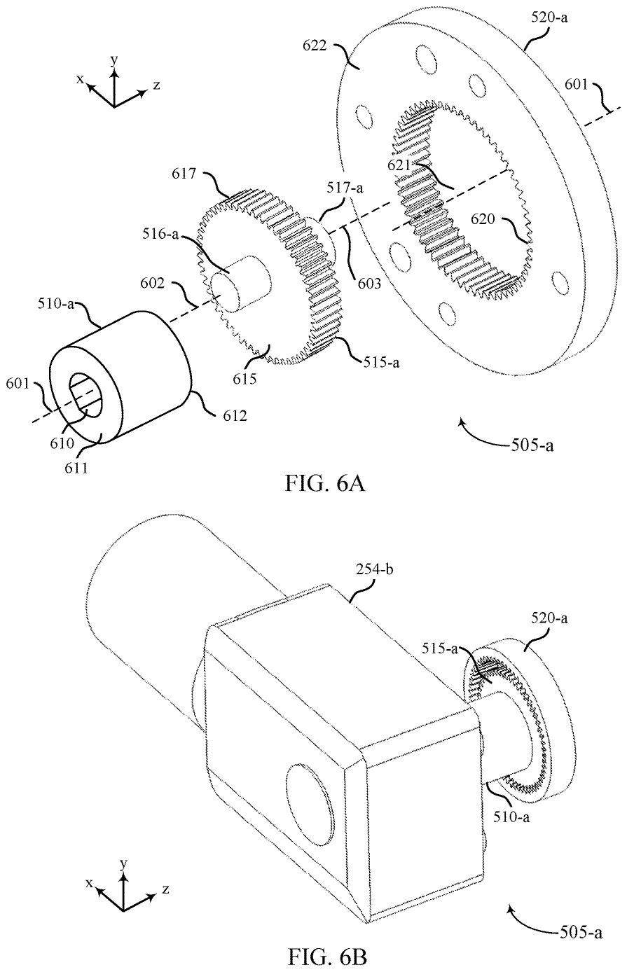

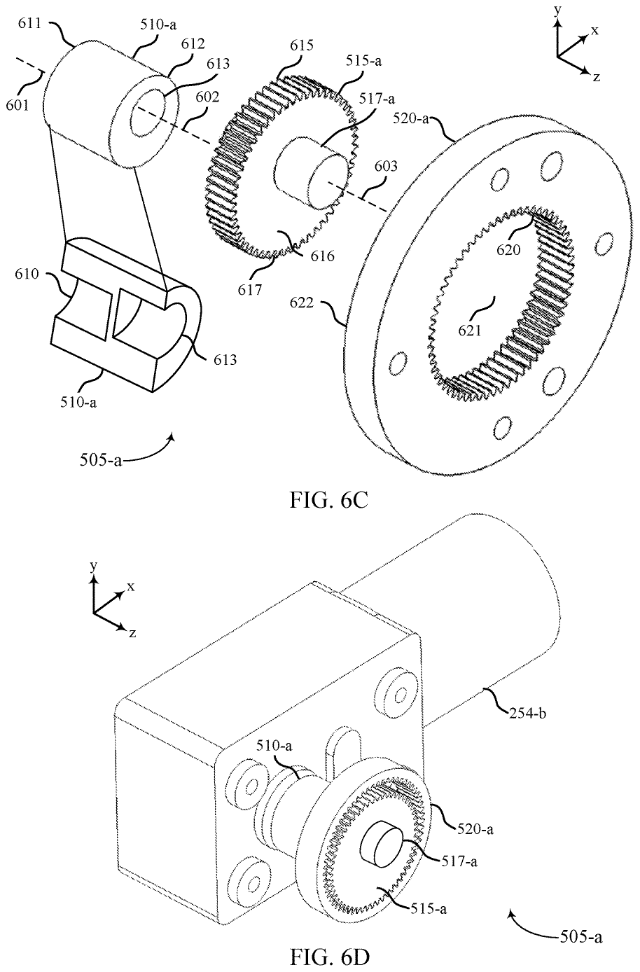

FIGS. 6A, 6B, 6C, and 6D show an example of a mechanism 505-a (e.g., a gear assembly) that supports techniques for peaking reflector antennas in accordance with examples as disclosed herein. The mechanism 505-a may be operable to displace an antenna feed assembly 310 based on actuation of a single drive interface. FIGS. 6A through 6D show the mechanism 505-a in various views relative to the illustrated coordinate system. For example, FIGS. 6A and 6C illustrate the mechanism 505-a with exploded diagonal (e.g., trimetric) views, and FIGS. 6B and 6D illustrate the mechanism 505-a with assembled diagonal views. The mechanism 505-a may be configured to displace an antenna feed assembly 310 based on actuation from a motor 254 or other actuator to support fine tuning of a beam communicated between an antenna system 155 and a target device.

The mechanism 505-a includes a drive coupling 510-a, a cog gear 515-a, and a ring gear 520-a. The drive coupling 510-a may include an interface 610 (e.g., a cavity, a bore) extending from a surface 611 of the drive coupling 510-a. The interface 610 may include a keyed structure or a d-hole, such that a torque applied via the interface 610 may cause the drive coupling 510-a to rotate about an axis 601. The drive coupling 510-a may include an interface 613 (e.g., a bore, a journal bearing, a rotational interface) extending from a surface 612 (e.g., opposite the surface 611) of the drive coupling 510-a and associated with an axis 602 (e.g., a centerline of the drive coupling 510-a). The interface 613 may be a cylindrical cavity that is offset from the axis 601 of the drive coupling 510-a, such that the interface 613 may rotate at a distance offset from the axis 601 during rotation of the drive coupling 510-a (e.g., an offset between the axis 601 and the axis 602).

The cog gear 515-a may include an interface 516-a (e.g., a pin, a journal pin, a rotational interface), which may be a cylindrical structure extending from a surface 615 of the cog gear 515-a. The interface 516-a may be configured for a rotatable coupling with the interface 613, such that the interface 516-a may fit within the interface 613. In some cases, the cog gear 515-a may include a spacer, and the interface 516-a may extend from a surface of the spacer. The interface 516-a may be located concentrically with an axis (e.g., centerline) of the cog gear 515-a. The cog gear 515-a may also include an interface 517-a (e.g., a pin, a journal pin, a rotational interface), which may be a cylindrical structure extending from a surface 616 (e.g., opposite the surface 615) of the cog gear 515-a. The interface 517-a may be located at a distance offset from a centerline of the cog gear 515-a, such that the interface 517-a may rotate at a distance about the centerline of the cog gear 515-a during rotation of the cog gear 515-a. In some examples, the cog gear 515-a may have a diameter (e.g., a reference diameter, a pitch circle) corresponding to 2*b of the geometry diagram 401 (e.g., a diameter of a circle 410), the interface 517-a may be associated with the point P, and the offset between the interface 516-a and the interface 517-a may correspond to the dimension h.

The ring gear 520-a may include a cavity 621 and teeth 620 (e.g., internal gear teeth) extending into the cavity 621. The cog gear 515-a may include teeth 617 (e.g., external gear teeth) extending out from a cylindrical surface of the cog gear 515-a, and the teeth 617 may mesh with the teeth 620 of the ring gear 520-a. That is, the cog gear 515-a may have a smaller diameter than the cavity 621 of the ring gear 520-a, such that the cog gear 515-a may rotate around an internal edge of the ring gear 520-a based on an interaction between the teeth 617 and the teeth 620. In some examples, the ring gear 520-a may have a diameter (e.g., a reference diameter, a pitch circle) corresponding to 2*a of the geometry diagram 401 (e.g., a diameter of a circle 405).

The interface 610 may be an example of a single drive interface that may be actuated by the motor 254-b (e.g., by a shaft of the motor 254-b that mates with the interface 610. For example, the interface 610 may be configured to at least rotationally constrain the drive coupling 510-a with an output shaft of the motor 254 or other actuator, such that rotation of the interface 610 may rotate the drive coupling 510-a. The drive coupling 510-a may be coupled with the cog gear 515-a via the interface 613 and the interface 516-a. For example, the interface 516-a may be a pin inserted within a cavity of the interface 613 and configured to rotate freely within the cavity of the interface 613. In some cases, the surface 612 of the drive coupling 510-a may be coplanar with the surface 615 of the cog gear 515-a, based on coupling the interface 516 with the interface 613. The cog gear 515-a may be coupled with the ring gear 520-a, such that the cog gear 515-a may rotate around the internal edge of the ring gear 520-a. In some cases, the surface 615 of the cog gear 515-a may be coplanar with a surface 622 of the ring gear 520-a. In some cases, the drive coupling 510-a, the ring gear 520-a, and the axis 601 may be concentric, such that rotation of the drive coupling 510-a may not displace the drive coupling 510-a from the axis 601. In some cases, the ring gear 520-a may be fixed, for example, to a flexure 530-a or a back plate of a signaling assembly housing 535-a (e.g., fixed relative to a reflector 220).

The drive coupling 510-a may drive the cog gear 515-a around the internal edge of the ring gear 520-a. For example, because the interface 613 (e.g., the axis 602) is radially offset a distance away from the axis 601 and the cog gear 515-a is concentric with the interface 613 (e.g., via the interface 516-a), as the drive coupling 510-a rotates, the cog gear 515-a may be rotated in a circular path at the distance away from the axis 601. For example, because the interface 613 and the cog gear 515-a share the axis 602, when the drive coupling 510-a is rotated, the axis 602 is rotated around the axis 601, thereby forming the circular path around which the cog gear 515-a travels. The circular path may force the cog gear 515-a to track along the internal edge of the ring gear 520-a, such that the teeth 617 and the teeth 620 facilitate movement of the cog gear 515-a about the ring gear 520-a (e.g., which is fixed).

The interface 517-a may be coupled with an antenna feed assembly 310, and thus may be configured to displace the antenna feed assembly 310 in a pattern formed by movement of the interface 517-a. For example, as the cog gear 515-a rotates around the internal edge of the ring gear 520-a, the interface 517-a may form a hypotrochoid pattern because of the offset centerlines of the cog gear 515-a and the interface 517-a. That is, the interface 517-a may be associated with axis 603 (e.g., a centerline of the interface 517-a) that is offset from the axis 602 of the cog gear 515-a, so rotation of the cog gear 515-a (e.g., along the internal edge of the ring gear 520-a) may cause the axis 603 to rotate about the axis 602. Thus, the interface 517-a may form a hypotrochoid pattern because the interface 517-a is rotating in a small loop for each rotation of the cog gear 515-a, and the cog gear 515-a is rotating in a larger loop around the ring gear 520-a.

In some cases, the mechanism 505-a may be configured to produce a path 415 based on the gear system operating in accordance with the displacement geometry diagram 401, as described with reference to FIGS. 4A and 4B. For example, the cog gear 515-a may correspond to a circle 410, the ring gear 520-a may correspond to a circle 405, and the interface 517-a may correspond to the point P within the circle 405. Thus, the interface 517-a (e.g., the axis 603) may displace along the displacement path diagram 402.

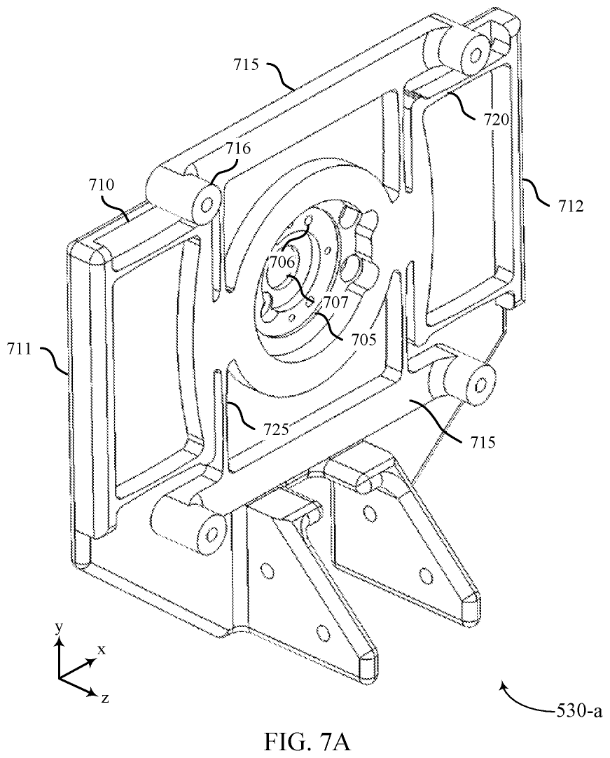

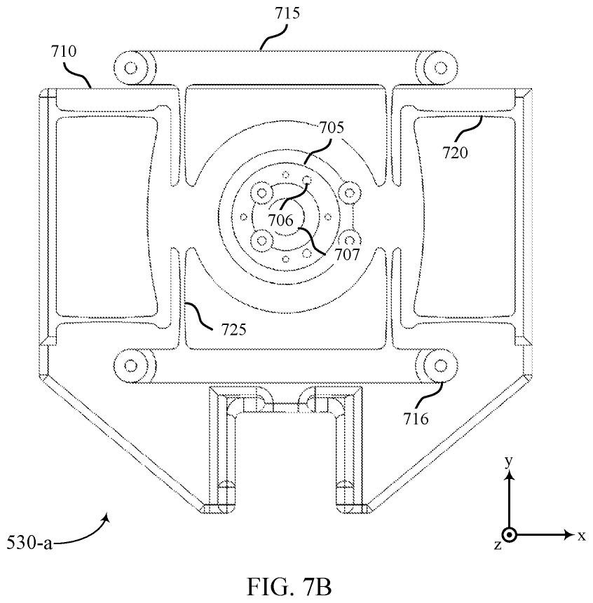

FIGS. 7A and 7B show an example of a flexure 530-a that supports techniques for peaking reflector antennas in accordance with examples as disclosed herein. The flexure 530-a may support displacement of an antenna feed assembly 310 based on actuation of a feed positioning mechanism 252. FIG. 7A illustrates the flexure 530-a in a diagonal view and FIG. 7B illustrates the flexure 530-a from a side view in an xy-plane (e.g., along the negative z-direction). At least a portion of the flexure 530-a may be a compliant member configured to support fine tuning of a beam (e.g., along a boresight 320) communicated between an antenna system 155 and a target device.

The flexure 530-a may include a mounting ring 705 configured to constrain a ring gear 520, such that the ring gear is fixed in at least an xy-plane (e.g., relative to a reflector 220). In some cases, the mounting ring 705 may be fixed within a structure 710 (e.g., a back plate) of the flexure 530-a to facilitate immobilization of the ring gear 520. The structure 710 may be included within a signaling assembly housing 535, and may be fixed relative to a reflector 220 (e.g., in at least an xy-plane). In some examples, a ring gear 520 may be connected with the mounting ring 705 by fasteners through mounting holes 706 of the mounting ring 705. The mounting ring 705 may include a hole 707 through which a drive coupling 510 may be located. In some cases, the mounting ring 705 may include space for a spacer of a cog gear 515.

The flexure 530-a may include structures 715 (e.g., feed assembly brackets) operable to fix an antenna feed assembly 310 to the flexure 530-a. In some examples, the structures 715 may be flexibly connected to the structure 710 via edges 711 and 712 of the structure 710, and the antenna feed assembly 310 may be rigidly connected to the structures 715 via mounting holes 716. Thus, the antenna feed assembly 310 may be fixed to the structures 715, however the structures 715 may float relative to the structure 710 (e.g., having a gap along the z-direction between edges 711 and 712). The structures 715 may be coupled with the structures 715 via compliant members 725 and compliant members 720 configured to support the structures 715, yet allow for movement of the structures 715. For example, the compliant members 725 may allow movement (e.g., be relatively compliant) along the x-direction, and the compliant members 720 may allow movement along the y-direction. In some cases, the flexure 530-a may be formed using a contiguous material, such that the structures 715 and the structure 710 are formed from a contiguous material (e.g., machined from a single block of material, three-dimensionally printed from a contiguous material).

An antenna feed assembly 310 may be displaced in the xy-plane based on an interaction of the flexure 530-a and a mechanism 505. For example, an interface 517 of a cog gear 515 may be configured to travel along a path having a hypotrochoid pattern in the xy-plane. The interface 517 may be coupled with the antenna feed assembly 310 (e.g., with a mating interface, such as a journal bearing or bushing), such that the interface 517 may move the antenna feed assembly 310 according to the hypotrochoid pattern. The flexure 530-a may support the antenna feed assembly 310, yet enable the antenna feed assembly 310 to travel along the path of the hypotrochoid pattern.

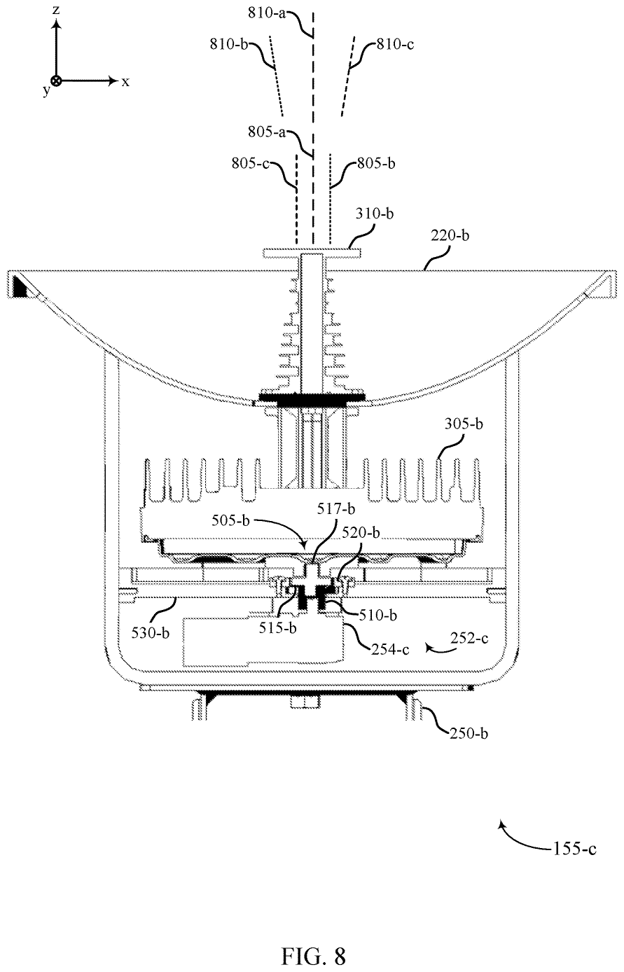

FIG. 8 shows an example of an antenna system 155-c that supports techniques for peaking reflector antennas in accordance with examples as disclosed herein. FIG. 8 illustrates the antenna system 155-c from a cross-sectional view in an xz-plane, and aspects of the antenna system 155-c may extend for some distance along the y-direction (e.g., into or out of the page). The antenna system 155-c may support fine tuning of a beam using a feed positioning mechanism 252-c.

The antenna system 155-c may be an example of a center-fed antenna system, and may include a reflector 220-b and an antenna feed assembly 310-b, which may be associated with an axis 805 (e.g., an axis of symmetry of signaling of the antenna feed assembly 310-b, an axis of symmetry of a signaling volume associated with the antenna feed assembly 310-b, a nominal axis of the antenna feed assembly 310-b, a centerline of the antenna feed assembly 310-b). When the axis 805-a is aligned with a centerline of the reflector 220-b, the antenna system 155-c may be associated with a boresight 810-a that is concentric with (e.g., colinear with) the axis 805-a. When the antenna feed assembly 310-b is displaced to the right (e.g., along the x-direction, using the feed positioning mechanism 252-c), the axis 805-b may be associated with a boresight 810-b (e.g., an adjusted boresight, tilted about the y-axis), and when the antenna feed assembly 310-b is displaced to the left, the axis 805-c may be associated with a boresight 810-c.

The antenna system 155-c may be mounted to an object (e.g., a house, a vehicle) via a mounting bracket assembly 250-b. The mounting bracket assembly 250-b may be configured to adjust an orientation of the antenna system 155-c relative to a mounting structure (e.g., a mast 258). In some examples, an installer (e.g., technician) may install the antenna system 155-c by connecting the mounting bracket assembly 250-b to a mast 258 or other object, and performing coarse tuning adjustments using the mounting bracket assembly 250-b.

The antenna system 155-c may include a signaling assembly 305-b that is fixed with the antenna feed assembly 310-b, and a feed positioning mechanism 252-c configured to displace both the signaling assembly 305-b and antenna feed assembly 310-b the relative to the reflector 220-b in an xy-plane. For example, the feed positioning mechanism 252-c may displace the signaling assembly 305-b and the antenna feed assembly 310-b in a hypotrochoid pattern based on a single drive interface actuating a mechanism 505-b coupled with the signaling assembly 305-b. The mechanism 505-b may include a drive coupling 510-b, a cog gear 515-b, and a ring gear 520-b. The drive coupling 510-b may be coupled with a motor 254-c, such that the motor 254-c may rotate the drive coupling 510-b.

The drive coupling 510-b may be coupled with the cog gear 515-b and configured to drive the cog gear 515-b along an internal edge of the ring gear 520-b. The ring gear 520-b may be fixed within the signaling assembly 305-b (e.g., based on a flexure 530-b) relative to the reflector 220-b, such that the cog gear 515-b may rotate within the ring gear 520-b. The cog gear 515-b may include an interface 517-b (e.g., a pin) offset from a centerline of the cog gear 515-b, such that rotating the cog gear 515-b around the ring gear 520-b may produce the hypotrochoid pattern at the interface 517-b. The interface 517-b may be coupled with the signaling assembly 305-b, such that the signaling assembly 305-b and the antenna feed assembly 310-b may be driven along a path of the hypotrochoid pattern based on actuation of the mechanism 505-b by the motor 254-c. The signaling assembly 305-b may include a flexure 530-b configured to support the antenna feed assembly 310-b along the z-direction, while enabling displacement of the feed in the xy-plane.

Similar to the offset-fed antenna system 155-b as shown in FIGS. 3A and 3B, the center-fed antenna system 155-c may be configured to perform fine tuning adjustments. For example, the signaling assembly 305-b may be configured to perform fine tuning adjustments by displacing the antenna feed assembly 310-b relative to the reflector 220-b to improve alignment between a boresight 810 and a target. The feed positioning mechanism 252-c may be configured to displace the antenna feed assembly 310-b based on measured signal characteristics of a signal communicated between the antenna system 155-c and the target (e.g., the satellite 120). A measurement device 286 may identify a position of the antenna feed assembly 310-b along the pattern with peak signal quality, and indicate the position to further actuate the feed positioning mechanism 252-c to position the antenna feed assembly 310-b. The feed positioning mechanism 252-c may drive the antenna feed assembly 310-b to the position of peak signal quality, thereby resulting in the antenna system 155-c being configured to produce relatively high gain along the direction of the target device.

Although an center-fed antenna system 155-c and an offset-fed antenna system 155-b may be configured to perform similar operations, the center-fed antenna system 155-c may physically differ from the offset-fed antenna system 155-b as shown in FIGS. 3A and 3B. For example, the center-fed antenna system 155-c may not include a structure 230-a configured to fix the signaling assembly 305-b to the reflector 220-b such that the antenna feed assembly 310-b is directed at the reflector 220-b, as in the offset-fed antenna system 155-b. Instead, in the center-fed antenna system 155-c, the antenna feed assembly 310-b is mounted within the reflector 220-b, and a feed positioning mechanism may be mounted on a back (e.g., a bottom) of the reflector 220-b.

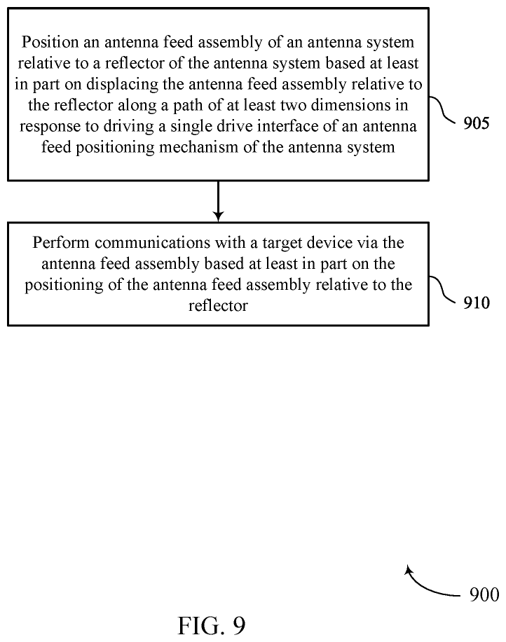

FIG. 9 shows a flowchart illustrating a method 900 that supports techniques for peaking reflector antennas in accordance with examples as disclosed herein. The operations of the method 900 may be implemented by an antenna system 155 or its components as described with reference to FIGS. 1 through 8. In some examples, an antenna system 155 may execute a set of instructions to control the functional elements of the antenna system 155 to perform the described functions. Additionally, or alternatively, the antenna system 155 may perform aspects of the described functions using special-purpose hardware.

At 905, the method may include positioning an antenna feed assembly 310 of the antenna system 155 relative to a reflector 220 of the antenna system 155 based at least in part on displacing the antenna feed assembly 310 relative to the reflector 220 along a path (e.g., a path 415) of at least two dimensions in response to driving a single drive interface of an antenna feed positioning mechanism 252 of the antenna system 155.

At 910, the method may include performing communications with a target device (e.g., a satellite 120) via the antenna feed assembly 310 based at least in part on the positioning of the antenna feed assembly 310 relative to the reflector 220.

In some examples, an apparatus (e.g., an antenna system 155, a user terminal 150) as described herein may perform a method or methods, such as the method 900. The apparatus may include features, circuitry, logic, means, or instructions (e.g., a non-transitory computer-readable medium storing instructions executable by a processor), or any combination thereof for performing aspects of the present disclosure.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The detailed description set forth above in connection with the appended drawings describes examples and does not represent the only examples that may be implemented or that are within the scope of the claims. The term “example,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with one or more processors (e.g., a processing system), which may include one or more of general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer readable medium. Other examples and implementations are within the scope of the disclosure and appended claims. For example, due to the nature of software, functions described herein can be implemented using software executed by one or more processors, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include random access memory (RAM), read-only memory (ROM), electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An antenna system, comprising:
a reflector;
an antenna feed assembly; and
an antenna feed positioning mechanism coupled between the reflector and the antenna feed assembly, the antenna feed positioning mechanism configured to displace the antenna feed assembly along a path, without displacing the reflector, in response to an actuation received via a single drive interface of the antenna feed positioning mechanism, the path of the antenna feed assembly associated with multiple instances of a path portion about an origin relative to the reflector, each instance of the path portion aligned along a respective angle about the origin.

2. The antenna system of claim 1, wherein the displacement of the antenna feed assembly causes a change in direction of peak gain of the antenna system relative to the reflector.

3. The antenna system of claim 1, wherein each of the multiple instances of the path portion comprises the origin.

4. The antenna system of claim 1, wherein the path of the antenna feed assembly is associated with a hypotrochoid pattern.

5. The antenna system of claim 1, wherein the antenna feed positioning mechanism is configured to displace the antenna feed assembly within a plane in response to the actuation received via the single drive interface.

6. The antenna system of claim 5, wherein the plane is perpendicular to a direction of peak signal gain associated with the antenna feed assembly.

7. The antenna system of claim 5, wherein the plane is perpendicular to an axis of symmetry of signal propagation to or from one or more feed elements of the antenna feed assembly.

8. The antenna system of claim 1, wherein the path is associated with a plurality of angles of a polar coordinate system relative to the reflector and, for each of the plurality of angles, a respective plurality of radial positions of the polar coordinate system.

9. The antenna system of claim 1, wherein the antenna feed positioning mechanism comprises:
a first structure configured with a fixed coupling relative to the reflector;
one or more second structures configured with a fixed coupling relative to the antenna feed assembly; and
a mechanism configured to translate the one or more second structures relative to the first structure in response to the actuation received via the single drive interface.

10. The antenna system of claim 9, wherein the mechanism comprises:
a drive coupling having the single drive interface as a first rotational interface along an axis of the drive coupling and a second rotational interface that is offset from the axis of the drive coupling;
a cog gear having external gear teeth, a third rotational interface that aligned with an axis of the cog gear and that is configured for a rotatable coupling with the second rotational interface, and a fourth rotational interface that is offset from the axis of the cog gear and that is configured for a rotatable coupling with one of the one or more second structures; and
a ring gear having a fixed coupling with the first structure and having internal gear teeth configured for a meshed coupling with the external gear teeth.

11. The antenna system of claim 10, wherein the fourth rotational interface is configured for translating the one or more second structures relative to the first structure in response to rotation of the drive coupling about the axis of the drive coupling.

12. The antenna system of claim 9, wherein the mechanism is configured to translate the one or more second structures along a hypotrochoid pattern relative to the first structure.

13. The antenna system of claim 9, wherein the antenna feed positioning mechanism comprises:
one or more compliant members between the first structure and at least one of the one or more second structures.

14. The antenna system of claim 1, further comprising:
a mounting bracket assembly coupled with the reflector and configured to collectively align the reflector and the antenna feed assembly along a nominal reflector orientation.

15. The antenna system of claim 1, further comprising:
a motor configured to rotate the single drive interface of the antenna feed positioning mechanism; and
one or more controllers operable to drive the motor based at least in part on signaling received via the antenna feed assembly.

16. The antenna system of claim 15, wherein the one or more controllers are operable to drive the motor based at least in part on a signal strength associated with the signaling communicated via the antenna feed assembly.

17. The antenna system of claim 15, wherein the one or more controllers are operable to drive the motor based at least in part on a command communicated via the antenna feed assembly.

18. The antenna system of claim 15, wherein the one or more controllers are operable to:
generate a signal strength pattern associated with the signaling received via the antenna feed assembly based at least in part on driving the motor through a completion of the path; and
drive the motor to establish a position of the antenna feed assembly based at least in part on generating the signal strength pattern.

19. The antenna system of claim 15, further comprising:
an encoder coupled with the motor, wherein the one or more controllers are operable to drive the motor to establish a position of the antenna feed assembly based at least in part on a rotational position indicated by the encoder.

20-43. (canceled)
